(19) United States
(12) Patent Application Publication
(10) Pub. No.: US 2025/0112385 A1
(43) Pub. Date: Apr. 3, 2025

(54) SELF-ALIGNING SMT CONTACTS

(71) Applicant: Apple Inc., Cupertino, CA (US)

(72) Inventors: James M. Jeon, Mountain House, CA (US); Ayoub Yari Boroujeni, San Jose, CA (US); James E. Harper, Paso Robles, CA (US); Mahmoud R. Amini, Sunnyvale, CA (US); Davood Mousanezhad Viyand, Santa Clara, CA (US)

(73) Assignee: Apple Inc., Cupertino, CA (US)

(21) Appl. No.: 18/374,496

(22) Filed: Sep. 28, 2023

(51) Int. Cl. H01R 12/70

(52) U.S. Cl. CPC H01R 12/707

(57) ABSTRACT

Structures, methods, and apparatus for soldering contacts of multiple connector receptacles to pads on a board while also providing high-speed data paths between the multiple connector receptacles and the pads on the board.

### BACKGROUND

The number of types of electronic devices that are commercially available has increased tremendously the past few years and the rate of introduction of new devices shows no signs of abating. Devices such as tablet computers, laptop computers, desktop computers, all-in-one computers, cell phones, storage devices, wearable-computing devices, portable media players, navigation systems, monitors and other display devices, audio devices, power adapters, and others, have become ubiquitous.

These electronic devices can share data and power over cables that have connector inserts at each end that can fit into connector receptacles in the electronic devices. These cables can include various conduits such as wires, fiber-optic cables, coaxial cables, and others.

Some of these electronic devices can include multiple connector receptacles. These connector receptacles can be mounted on a board or other appropriate substrate in the electronic device. The connector receptacles can have housings that define passages that can align with openings in an enclosure of the electronic device. A corresponding connector insert can be inserted through an opening in the enclosure and into the passage of the connector receptacle. Contacts in the connector insert can form electrical connections with contacts in the connector receptacle.

It can be difficult to position the contacts of multiple connector receptacles such that they can be soldered to pads on the board. For example, each board can be formed of several layers stacked upon each other. As a result, a surface having pads to be soldered to the contacts might not be planer. Also, the surface can be or become warped during manufacturing due to temperature fluctuations and other causes. Complicating the formation of these connections can be the need to provide high-frequency signal paths through these connector receptacle contacts and board pads.

Thus, what is needed are structures, methods, and apparatus for soldering contacts of multiple connector receptacles to pads on a board while also providing high-speed data paths between the multiple connector receptacles and the pads on the board.

### SUMMARY

Accordingly, embodiments of the present invention can provide structures, methods, and apparatus for soldering contacts of multiple connector receptacles to pads on a board while also providing high-speed data paths between the multiple connector receptacles and the pads on the board. An illustrative embodiment of the present invention can provide structures that can compensate for warpage or other nonplanar artifacts on a board when mounting a number of connector receptacles to the board. These structures can also compensate for nonplanarity of the contacts that are being soldered to the board, as well as misalignments between individual connector receptacles. These structures can also provide a high-frequency path through the contacts and corresponding pads on the board that the contacts are soldered to.

In these and other embodiments of the present invention, a plurality of connector receptacles can be housed in a frame. Each connector receptacle can include a housing supporting a number of contacts. The contacts can be positioned on a tongue and the tongue can be supported by the housing. Each contact can be attached to a corresponding solder tail. Each contact can have a first region coated with a non-solderable coating. Each solder tail can have a second region coated with a non-solderable coating. Each solder tail can have an end to attach to a pad on a board. The second region can be between the first region and the end of the solder tail. The end of each solder tail can be angled to form a surface-mount contacting portion.

Each contact can be attached to a corresponding solder tail by a solder region. The solder region can be at least partially between the first region and the second region. In these and other embodiments of the present invention, the solder region can be substantially between the first region and the second region. During assembly, the solder region can be heated above the melting temperature of the solder. This heating can be done by laser, reflow, or other process. As the solder melts, the surface energy of the solder increases. As a result, the surface of the soldered area can increase. This can push the solder tail such that the distance between the first region and the second region is increased.

The plurality of connector receptacles housed in a frame can be attached to a board. Initially, the solder tails can be positioned such that they are above the board and the solder tails do not make contact with pads on the board. During assembly, the solder regions can be heated above the melting temperature of the solder. The first regions and second regions can move away from each other. The first regions can be fixed relative the housing, meaning that the second regions and the ends of the solder tails can move downward until the solder tails make contact with pads on the board. A second soldering step, such as a reflow, can be done to solder the solder tails to the pads. The first reflow or laser step can be done at a lower temperature and the second reflow step can be done at a higher temperature, though the first reflow or laser step can be done at a higher temperature and the second reflow step can be done at a lower temperature, or both steps can be done at the same temperature. The two steps can also be done at the same time in these and other embodiments of the present invention.

The non-solderable coatings used for the first region and the second region can be formed of ceramics or other materials. The non-solderable coatings can be applied using vapor deposition, sprays, or other techniques. The non-solderable coatings can be formed by plating, for example they can be nickel plating, or other types of plating. The mix of materials in the solder that is used can determine the type of plating that can form a non-solderable coating.

In these and other embodiments of the present invention, the solder tail can include an angled portion forming a surface-mount contacting portion. This can provide a high-frequency signal path through a contact, solder tail, and pad on the board. This is particularly true as compared to through-hole contacting portions, which pass through several layers of a board and can have stray capacitive coupling to the different traces in the board. By providing these surface-mount contacting portions that can move to make contact with a pad on a board, it can be possible for the several connector receptacles in a frame to be reliably mounted on a board in an electronic device.

These and other embodiments of the present invention can provide a plurality of connector receptacles supported by a frame. Each connector receptacle can include a housing forming a passage. A number of contacts can be supported by the housing. Each of the plurality of contacts can have a first region at or near and end of the contact, where the first region is coated with a non-solderable coating. Each contact can be attached to a corresponding solder tip. Each solder tip can be a volume of solder. The first region can extend from at least a surface of the solder tip a distance away from the solder tip. In these and other embodiments of the present invention, the first region can extend from within the solder tip a distance away from the solder tip.

During assembly, the volume of solder making up the solder tips can be heated above the melting temperature of the solder. This heating can be done by laser, reflow, or other process. As the solder melts, the surface energy of the solder increases. As a result, the volume of solder can move away from the first region.

The plurality of connector receptacles housed in a frame can be attached to a board. Initially, the solder tips can be positioned such that they are above the board and the solder tips do not make contact with pads on the board. During assembly, the volumes of solder can be heated above the melting temperature of the solder. The volume of solder can move away from the first region. The first regions can be fixed relative the housing, meaning that the solder tips can move until the solder tails make contact with pads on the board.

These and other embodiments of the present invention can provide a plurality of connector receptacles supported by a frame. Each connector receptacle can include a housing forming a passage. A number of contacts can be supported by the housing. Each of the plurality of contacts can have a length that is longer than a distance to a board. Holes can be formed in a top surface of the board, where each hole is in a position aligned with a contact. The holes can be filled with a volume of solder, such as a solder paste. During assembly, the contacts can be inserted into the holes filled with solder paste. This can compensate for nonplanar aspects of the board, the connector receptacles, and the contacts. This arrangement can also provide a high-frequency performance similar to that of a surface-mount contacting portion.

These and other embodiments of the present invention can provide a connector receptacle structure. The connector receptacle structure can include a frame having a plurality of slots. A plurality of connector receptacles can each be located in a corresponding one of the plurality of slots. The connector receptacles can move within the slots in the frame to compensate for nonplanarities in the board, connector receptacles, and contacts of the connector receptacles. For example, each connector receptacle can move in its corresponding slot through a first range in a first direction, a second range in a second direction, and a third range in a third direction, wherein the first direction, the second direction, and the third direction are orthogonal. The first range, the second range, and the third range can be the same or different ranges. Each of the plurality of connector receptacles can include a housing and a plurality of contacts supported by the housing. Each of the plurality of contacts can include a surface-mount contacting portion, wherein the first direction is the vertical direction and the surface-mount contacting portions are below the housing.

The frame can include a plurality of openings in a top portion such that a top of each housing of the connector receptacles is accessible through a corresponding one of the plurality of openings in the top portion of the frame. This can allow a force to be applied to the top of each housing of each of the connector receptacles through a corresponding one of the plurality of openings in the top portion of the frame. This force can be applied during a reflow step to ensure proper contact between each of the surface-mount contacting portions and corresponding pads on a board. The force can be applied by one structure having extensions, where each extension fits in a corresponding one of the plurality of openings in the top portion of the frame. In another embodiment, springs can be placed in the openings and positioned between tops of the connector receptacle housings and a shield or other portion over the top of the frame. The individual springs can apply a force to assist in the connection of the contacts of each connector receptacle and pads on a board. A force can be applied to the frame as a whole as well during reflow.

During reflow, a reflow cap can be placed over a front of the connector receptacle structure. The reflow cap can include holders that can keep tongues of the connector receptacles aligned in a lateral direction. Locating pins can maintain alignment in a front-to-back direction. The forces applied through openings in a top of the frame, or by forces applied by springs in the frame and applied to the frame as a whole, can align the connector receptacle structure in a vertical direction. An alignment pin on the frame can align the connector receptacle structure to an enclosure of an electronic device.

In various embodiments of the present invention, contacts, shields, and other conductive portions of a connector receptacle or connector receptacle structure can be formed by stamping, metal-injection molding, machining, micro-machining, 3-D printing, or other manufacturing process. The conductive portions can be formed of stainless steel, steel, copper, copper titanium, phosphor bronze, or other material or combination of materials. They can be plated or coated with nickel, gold, or other material. The nonconductive portions, such as the reflow caps, housings, frames, and other structures can be formed using injection or other molding, 3-D printing, machining, or other manufacturing process. The nonconductive portions can be formed of silicon or silicone, rubber, hard rubber, plastic, nylon, liquid-crystal polymers (LCPs), ceramics, or other nonconductive material or combination of materials. The printed circuit boards used can be formed of FR-4 or other material.

Embodiments of the present invention can provide connector receptacles that can be located in, and can connect to, various types of devices, such as portable computing devices, tablet computers, desktop computers, laptops, all-in-one computers, wearable computing devices, cell phones, smart phones, media phones, storage devices, portable media players, navigation systems, monitors, audio devices, power supplies, video delivery systems, adapters, remote control devices, chargers, and other devices. These connector receptacles can provide interconnect pathways for signals that are compliant with various standards such as one of the Universal Serial Bus (USB) standards including USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. Other embodiments of the present invention can provide connector receptacles that can be used to provide a reduced set of functions for one or more of these standards. In various embodiments of the present invention, these interconnect paths provided by these connector receptacles can be used to convey power, ground, signals, test points, and other voltage, current, data, or other information.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates an electronic system that can be improved by the incorporation of embodiments of the present invention;

FIG. 2 illustrates a connector receptacle structure according to an embodiment of the present invention;

FIG. 3 illustrates a cutaway side view of a connector receptacle according to an embodiment of the present invention;

FIG. 4A and FIG. 4B illustrate a portion of a connector receptacle including a solder tail according to an embodiment of the present invention;

FIG. 5A and FIG. 5B illustrate a portion of a connector receptacle including a solder tail according to an embodiment of the present invention;

FIG. 6 illustrates a portion of a connector receptacle including a solder tail according to an embodiment of the present invention;

FIG. 7 illustrates a cutaway side view of a connector receptacle according to an embodiment of the present invention;

FIG. 8A and FIG. 8B illustrate portions of a connector receptacle including a solder tip according to an embodiment of the present invention;

FIG. 9 illustrates a cutaway side view of a connector receptacle according to an embodiment of the present invention;

FIG. 10A, FIG. 10B, and FIG. 10C illustrate a method of forming connections between a connector receptacle and a board according to an embodiment of the present invention;

FIG. 11 illustrates a connector receptacle structure according to an embodiment of the present invention;

FIG. 12 illustrates a reflow cap and a connector receptacle structure according to an embodiment of the present invention; and

FIG. 13 illustrates another connector receptacle structure according to an embodiment of the present invention.

### DESCRIPTION OF ILLUSTRATIVE EMBODIMENTS

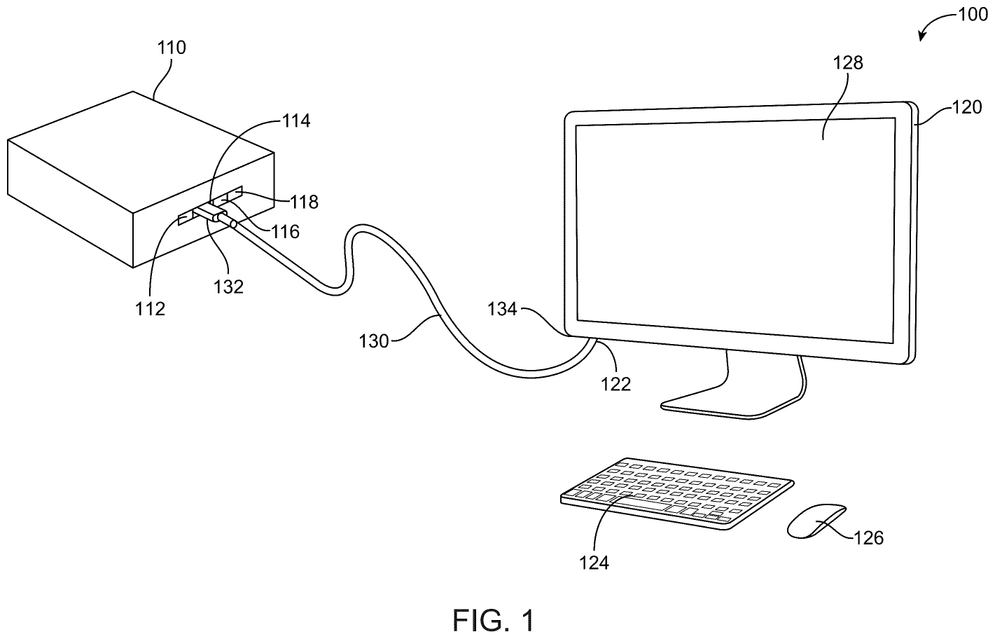

FIG. 1 illustrates an electronic system that can be improved by the incorporation of an embodiment of the present invention. This figure, as with the other included figures, is shown for illustrative purposes and does not limit either the possible embodiments of the present invention or the claims.

Electronic system 100 can include computing device 110 and monitor 120. Computing device 110 can include connector receptacle 112, connector receptacle 114, connector receptacle 116, and connector receptacle 118. Monitor 120 and computing device 110 can communicate with keyboard 124 and mouse 126. Monitor 120 can include screen 128. Monitor 120 can include connector receptacle 122.

Cable 130 can convey power and data between computing device 110 and monitor 120. Cable 130 can include a connector insert 132 at a first end that can be plugged into connector receptacle 114 of computing device 110. Cable 130 can further include connector insert 134 at a second end that can be plugged into a connector receptacle of monitor 120, for example connector receptacle 122 of monitor 120.

In this example, electronic system 100 is shown as including computing device 110 and monitor 120. In these and other embodiments of the present invention, electronic system 100 can include other types of devices. Also, while computing device 110 is shown as a desktop computer and monitor 120 is shown as a desktop monitor, either or both can be other types of devices, such as laptop computers, handheld computing devices, all-in-one computers, smart phones, storage devices, wearable-computing devices, portable computing devices, portable media players, navigation systems, audio devices, remotes, adapters, and other devices.

Embodiments of the present invention can provide connector receptacles, such as connector receptacle 112 and connector receptacle 122, and connector inserts, such as connector insert 132 and connector insert 134, that are compliant with various standards such as Universal Serial Bus (USB), USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future.

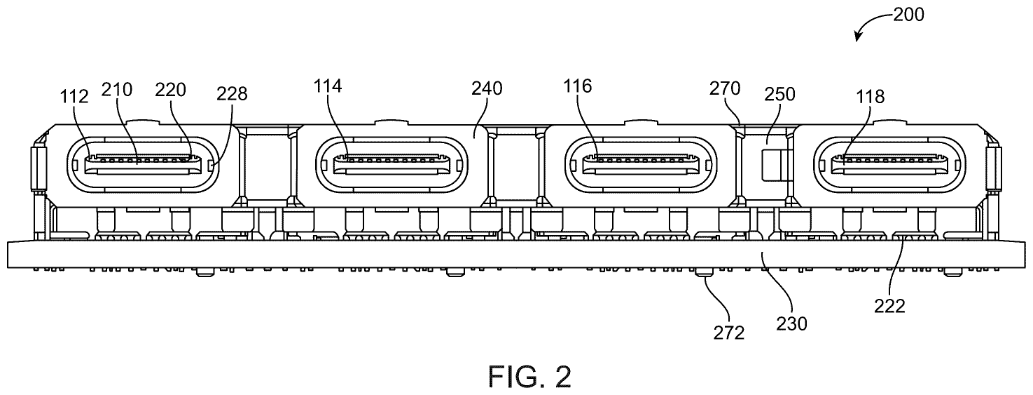

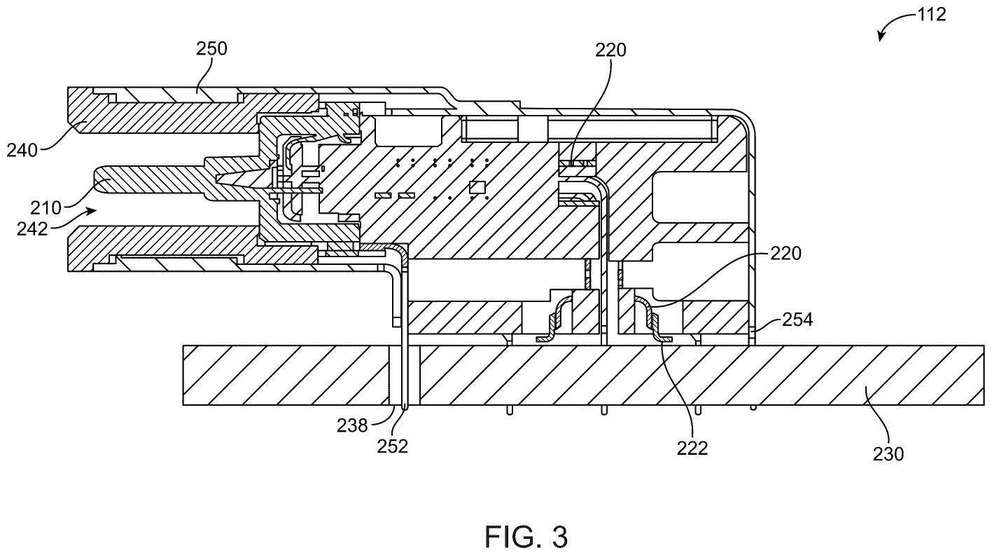

FIG. 2 illustrates a connector receptacle structure according to an embodiment of the present invention. Connector receptacle structure 200 can be housed in an electronic device, such as computing device 110, monitor 120 (both shown in FIG. 1), or other electronic device. Connector receptacle structure 200 can include a number of connector receptacles, including connector receptacle 112, connector receptacle 114, connector receptacle 116, and connector receptacle 118, collectively referred to here as connector receptacle 112. Each connector receptacle 112 can include housing 240 that forms a passage 242 (shown in FIG. 3) for access to tongue 210. Tongue 210 can support a plurality of contacts 220 on a top and bottom side. Each tongue 210 can be flanked by side ground contacts 228. Connector receptacles 112 can be supported by a frame 270 that is shielded by shield 250. Frame 270 can be aligned to board 230 by frame posts 272.

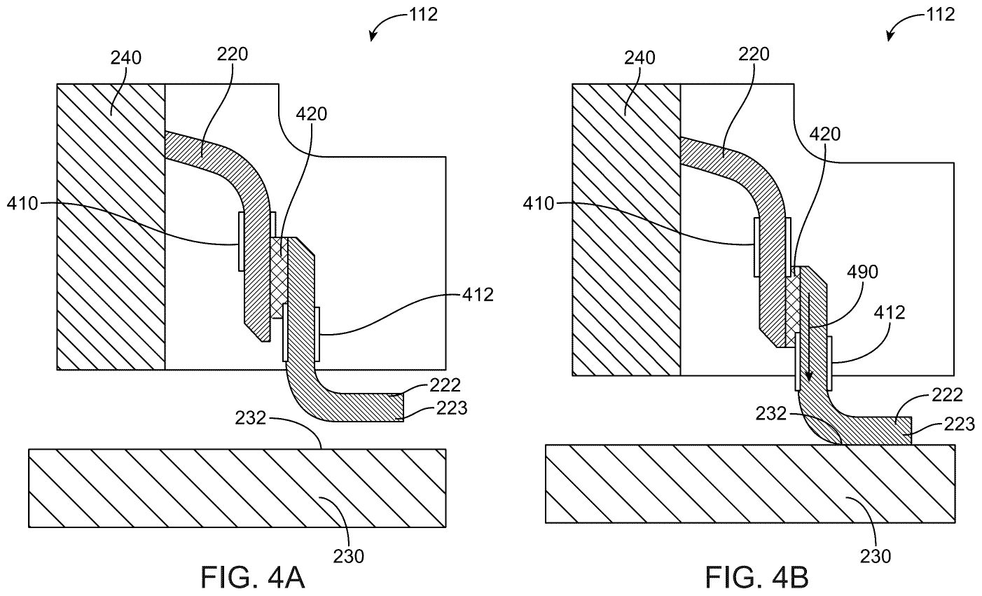

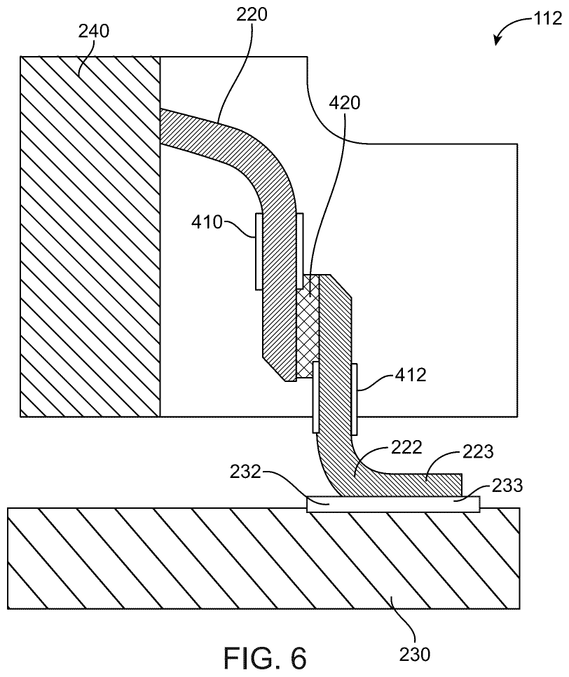

Some or all contacts 220 in some or all of connector receptacles 112 can terminate in solder tails 222. Solder tails 222 can be soldered to corresponding pads 232 (shown in FIG. 6) on board 230. Solder tails 222 can include surface-mount contacting portions 223 (shown in FIG. 4A) to improve high-frequency performance. But again, it can be difficult to form electrical connections between solder tails 222 and corresponding pads 232 on board 230. For example, board 230 can include several layers that can disrupt the planarity of a surface of board 230. Also, board 230 can warp during or after manufacturing. Similarly, connector receptacles 112 can be misaligned with each other in frame 270. It can also be difficult to arrange solder tails 222 such that they lie in the same plane. Accordingly, embodiments of the present invention can provide solder tails 222 that can compensate for these various effects. An example is shown in the following figures.

FIG. 3 illustrates a cutaway side view of a connector receptacle according to an embodiment of the present invention. Connector receptacle 112 can include housing 240 forming passage 242 for access to tongue 210. Tongue 210 can support a number of contacts 220 on a top side and a bottom side. Housing 240 can be shielded by shield 250. Extension 252 of shield 250 can be inserted into and soldered to through-hole 238 in board 230. Extension 254 of shield 250 can similarly be inserted into and soldered to a through-hole (not shown) in board 230.

Contacts 220 can each be attached to a corresponding solder tail 222. Solder tails 222 can form electrical connections with pads 232 (shown in FIG. 6) on board 230. To form these connections, solder tails 222 can move relative to contacts 220. This movement can drive solder tails 222 downward (as drawn) such that they can be properly soldered to pads 232 during a reflow process. Details of this are shown in the following figures.

FIG. 4A and FIG. 4B illustrate a portion of a connector receptacle including a solder tail according to an embodiment of the present invention. FIG. 4A illustrates a portion of connector receptacle 112 including housing 240 supporting contact 220. Solder tail 222 can be attached to contact 220 by solder region 420. Contact 220 can have first region 410 coated with a non-solderable coating. Solder tail 222 can include second region 412 coated with a non-solderable coating. Solder tail 222 can include an angled portion that can form a surface-mount contacting portion 223. Solder tail 222 can be originally positioned above pad 232 on board 230.

In FIG. 4B, solder region 420 can be heated to at least a temperature where the solder in solder region 420 melts. The melting process can increase a surface energy of the solder in solder region 420. This increase in surface energy can increase the surface area that the solder adheres to on contact 220 and solder tail 222. This increase in surface area can act to push first region 410 and second region 412 away from each other. Since contact 220 is fixed to housing 240, second region 412 can move downward (as drawn). That is, the increased surface energy can provide a force 490 that pushes solder tail 222 to pad 232 on board 230.

Again, solder tail 222 can include surface-mount contacting portion 223. Solder tail 222 can be angled to provide surface-mount contacting portions 223. This can improve the high-speed performance of contacts 220 in connector receptacles 112. The distance that solder tails 222 move can vary across board 230, it can vary between connector receptacles 112, and it can vary between contacts 220 in a specific connector receptacle 112. By providing a sufficient range travel for solder tails 222, variations in board planarity, connector receptacle consistency, and contact nonplanarity, can be compensated for.

The non-solderable coatings used for first region 410 and second region 412, and the other non-solderable regions shown here, can be formed of ceramics or other materials. The non-solderable coatings can be applied using vapor deposition, sprays, or other techniques. The non-solderable coatings can be formed by plating, for example they can be nickel plating, or other types of plating. The mix of materials in the solder that is used in forming solder region 420 can determine the type of plating that can form a non-solderable coating.

In this example, solder region 420 can be heated by a reflow or other process. Other methods of heating solder region 420 can be used. For example, solder region 420 can be heated by a laser. An example is shown in the following figures.

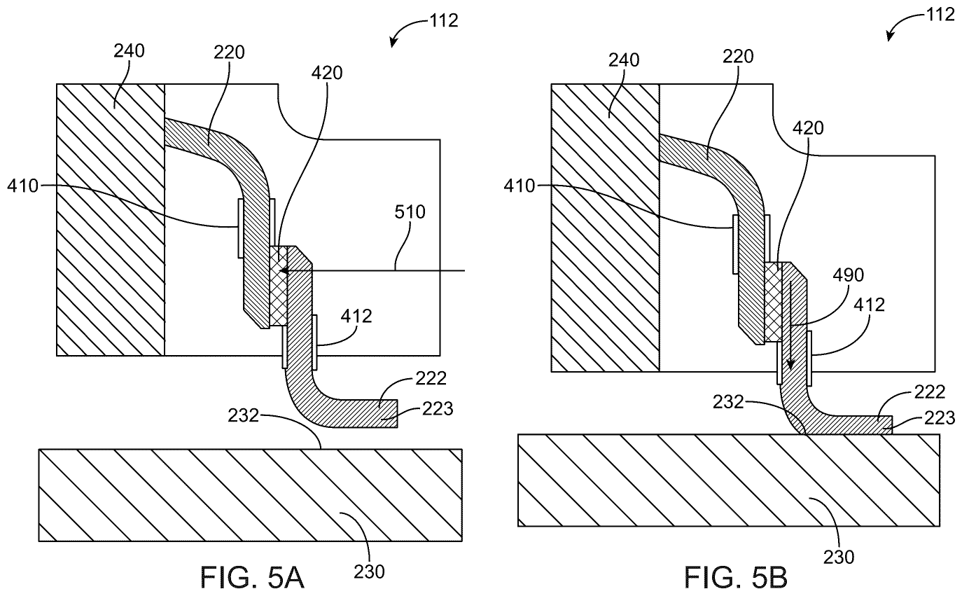

FIG. 5A and FIG. 5B illustrate a portion of a connector receptacle including a solder tail according to an embodiment of the present invention. FIG. 5A illustrates a portion of connector receptacle 112 including housing 240 supporting contact 220. Solder tail 222 can be attached to contact 220 by solder region 420. Contact 220 can have first region 410 coated with a non-solderable coating. Solder tail 222 can include second region 412 coated with a non-solderable coating. Solder tail 222 can include an angled portion that can form surface-mount contacting portion 223. Solder tail 222 can be originally positioned above pad 232 on board 230. Solder region 420 can be heated using laser beam 510 to at least a temperature where the solder in solder region 420 melts.

In FIG. 5B, the melting process can increase a surface energy of the solder in solder region 420. This increase in surface energy can increase the surface area that the solder adheres to on contact 220 and solder tail 222. This increase in surface area can act to push first region 410 and second region 412 away from each other. Since contact 220 is fixed to housing 240, second region 412 can move downward (as drawn). That is, the increased surface energy can provide a force 490 that pushes solder tail 222 to pad 232 on board 230.

Again, solder tail 222 can include surface-mount contacting portion 223. Contacts 220 can be angled to provide a surface-mount contacting portion 223. This can improve the high-speed performance of contacts 220 in connector receptacles 112. The distance that solder tails 222 move can vary across board 230, it can vary between connector receptacles 112, and it can vary between contacts 220 in a specific connector receptacle 112. By providing a sufficient range travel for solder tails 222, variations in board planarity, connector receptacle consistency, and contact nonplanarity, can be compensated for.

FIG. 6 illustrates a portion of a connector receptacle including a solder tail according to an embodiment of the present invention. In this example, solder region 420 has been heated, for example using heat from a reflow processes or laser beam 510 (shown in FIG. 5A.) Second region 412 has been pushed away from first region 410, again since contact 220 is fixed in position by housing 240. This can push surface-mount contacting portion 223 of solder tail 222 into contact with pad 232 on board 230. Solder 233 can be applied to pad 232 during a reflow or other process.

In these and other embodiments of the present invention, the first reflow or laser step can be done at a lower temperature and the second reflow step can be done at a higher temperature, though the first reflow or laser step can be done at a higher temperature and the second reflow step can be done at a lower temperature, or both steps can be done at the same temperature. The two steps can also be done at the same time in these and other embodiments of the present invention.

In these and other embodiments of the present invention, solder tail 222 can include an angled portion forming a surface-mount contacting portion 223. This can provide a high-frequency signal path through contact 220, solder tail 222, and pad 232 on board 230. This is particularly true as compared to through-hole contacting portions, which pass through several layers of a board and can have stray capacitive coupling to the different traces in the board. By providing these surface-mount contacting portions 223 that can move to make contact with pad 232 on board 230, it can be possible for several connector receptacles 112 in frame 270 to be reliably mounted on board 230 in an electronic device (not shown.)

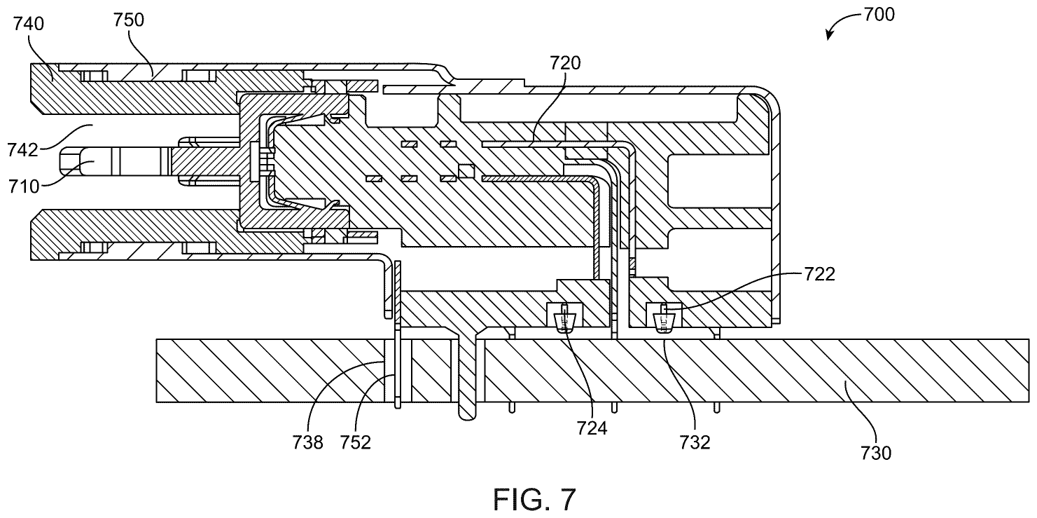

FIG. 7 illustrates a cutaway side view of a connector receptacle according to an embodiment of the present invention. Connector receptacle 700 can be used in place of connector receptacle 112 (shown in FIG. 3.) Connector receptacle 700 can include housing 740 forming passage 742 for access to tongue 710. Tongue 710 can support a number of contacts 720 on a top side and a bottom side. Housing 740 can be shielded by shield 750. Extension 752 of shield 250 can be inserted into and soldered to through-hole 738.

Contacts 720 can each have an end 722 that be attached to a corresponding solder tip 724. Solder tips 724 can form electrical connections with pads 732 on board 730. To form these connections, solder tips 724 can move relative to ends 722 of contacts 720. This movement can drive solder tips 724 downward (as drawn) such that they can be properly soldered to pads 732 during a reflow process. Details of this are shown in the following figures.

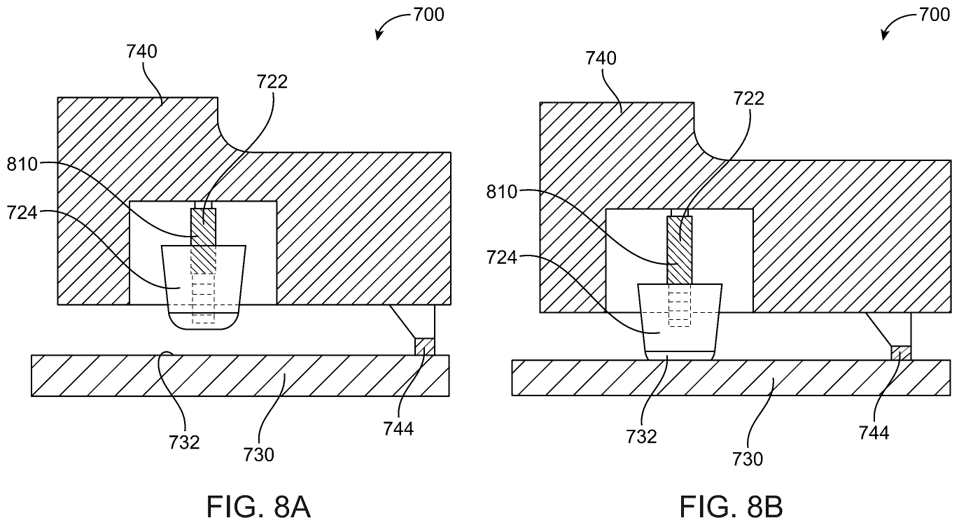

FIG. 8A and FIG. 8B illustrate portions of a connector receptacle including a solder tip according to an embodiment of the present invention. In FIG. 8A, solder tip 724 can be attached to end 722 of a contact 720 (shown in FIG. 7.) End 722 can include first region 810. First region 810 can be coated with a non-solderable coating. This non-solderable coating can be the same non-solderable coating used to form the first region 410 and second region 412 (both shown in FIG. 4A.) Housing 740 of connector receptacle 700 can be positioned by standoffs 744, which can be in contact with board 730.

Solder tip 724 can be heated, for example during a reflow process, with a laser, or by other technique. When a melting temperature of the solder in solder tip 724 is reached, the solder of solder tip 724 can begin to flow. This can increase the surface energy of solder in solder tip 724. This increased surface energy can move the solder of solder tip 724 away from first region 810. This can be in a downward direction where it can form in electrical connection with pad 732.

In FIG. 8B, solder tip 724 has been heated above its melting temperature for example, using a reflow process, laser, or other procedure. This can cause the solder in solder tip 724 to move away from first region 810 on end 722 of contact 720 (shown in FIG. 7.) This movement can push the solder in solder tip 724 into contact with pad 732 on board 730. End 722 of contact 720 can be fixed in position by housing 740. Housing 740 can be positioned relative to board 730 by standoffs 744.

The distance that solder tips 724 can move can vary across board 730, it can vary between connector receptacles 700, and it can vary between contacts 720 in a specific connector receptacle 700. By providing a sufficient range travel for solder tips 724, variations in board planarity, connector receptacle consistency, and contact nonplanarity, can be compensated for.

The non-solderable coatings used for first region 810, and the other non-solderable regions shown here, can be formed of ceramics or other materials. The non-solderable coatings can be applied using vapor deposition, sprays, or other techniques. The non-solderable coatings can be formed by plating, for example they can be nickel plating, or other types of plating. The mix of materials in the solder that is used in forming solder tips 724 can determine the type of plating that can form a non-solderable coating.

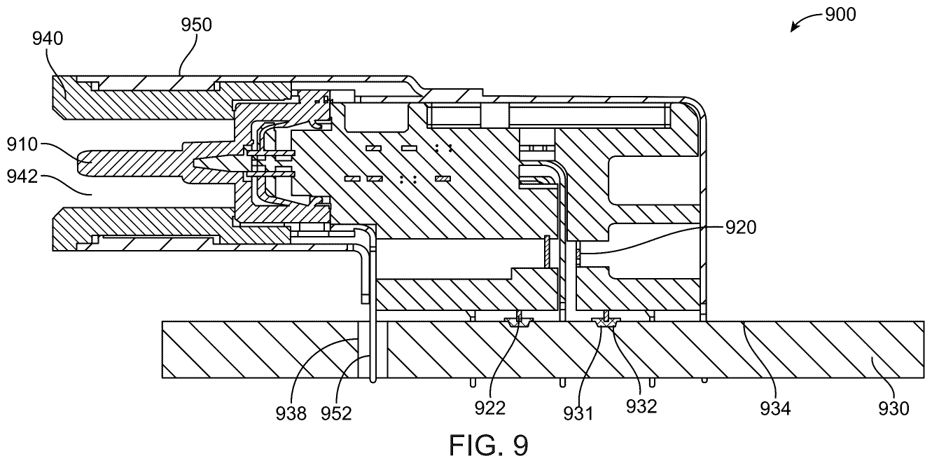

FIG. 9 illustrates a cutaway side view of a connector receptacle according to an embodiment of the present invention. Connector receptacle 900 can be used in place of connector receptacle 112 (shown in FIG. 3.) Connector receptacle 900 can include housing 940 forming passage 942 for access to tongue 910. Tongue 910 can support a number of contacts 920 on a top side and a bottom side. Housing 940 can be shielded by shield 950. Extension 952 of shield 950 can be inserted into and soldered to through-hole 938.

Contacts 920 can each include an end 922 that can be soldered to pads 932. Pads 932 can be formed by placing solder paste in holes 931 in top surface 934 of board 930. Ends 922 of contacts 920 can be inserted into the solder in holes 931 to various depths, thereby compensating for warpage of board 930, mismatches between connector receptacles 900, and nonplanarity of ends 922 of contacts 920.

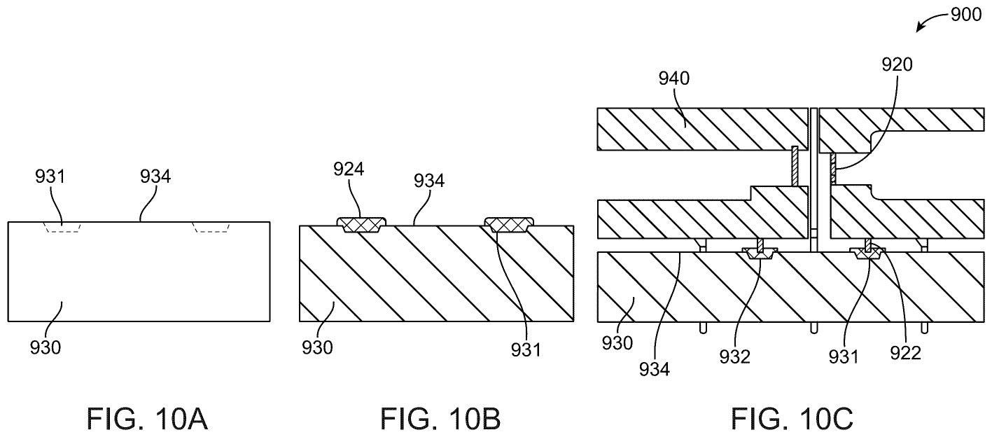

FIG. 10A, FIG. 10B, and FIG. 10C illustrates a method of forming connections between a connector receptacle and a board according to an embodiment of the present invention. In FIG. 10A, holes 931 can be formed in a top surface 934 of board 930. In FIG. 10B, solder paste can be used to fill holes 931 to form pads 932 in top surface 934 of board 930.

In FIG. 10C, connector receptacle 900 can be attached to board 930. Specifically contacts 920 can be supported by housing 940. Contacts 920 can each include an end 922. Ends 922 can be inserted into the solder forming pads 924 during a reflow process. Pads 932 in holes 931 in top surface 934 of board 930 can connect to traces or planes (not shown) in board 930.

In these and other embodiments of the present invention, one or more connector receptacles can be housed in corresponding slots in a frame. Each connector receptacle can be able to move through a first range in a first direction, a second range in a second direction, and a third range in a third direction, where the first direction, second direction, and third direction are orthogonal. The first range, the second range, and the third range can be the same or different ranges. In these and other embodiments of the present invention, posts extending from the frame can be used to align the frame to a board. Posts extending from housings of the connector receptacles can position each connector receptacle in a first direction and a second direction. A force can be applied to each connector receptacle in the third direction towards the board during assembly. This force can be applied during reflow or other process to solder contacts of the connector receptacles to corresponding pads on the board. The force can be applied to the housings of the connector receptacles through openings in the frame. The force can be applied by springs that are located between a shield over the frame and the housings of the connector receptacles. These spring forces can be supplemented by a force pushing the frame towards the board during reflow or other soldering step. Examples are shown in the following figures.

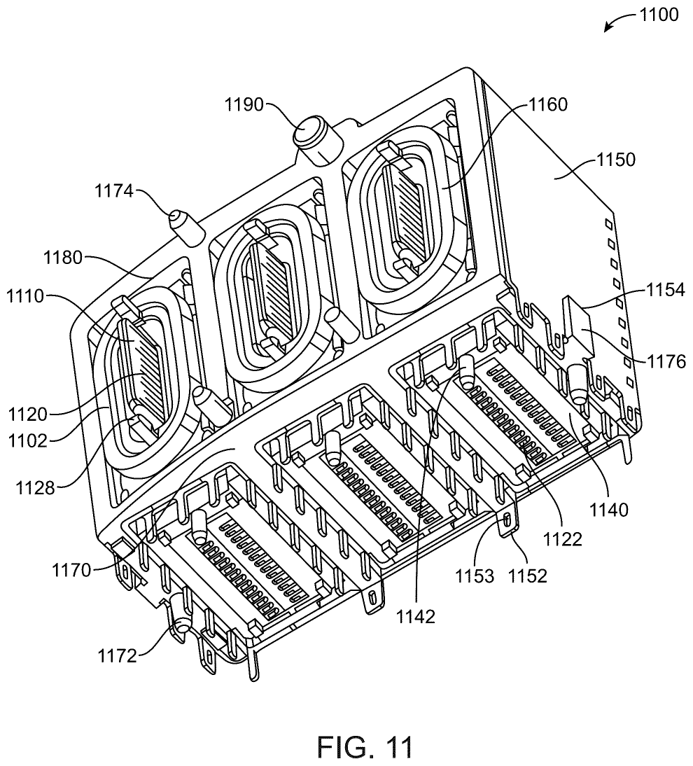

FIG. 11 illustrates a connector receptacle structure according to an embodiment of the present invention. Connector receptacle structure 1100 can be housed in an electronic device, such as computing device 110, monitor 120 (both shown in FIG. 1), or other electronic device. Connector receptacle structure 1100 can include frame 1170 having a number of slots 1180. Connector receptacles 1102 can each be positioned in a corresponding slot 1180 in frame 1170. Connector receptacles 1102 can each move through a range of distances within slots 1180. Specifically, connector receptacles 1102 can each move through a first range in a first direction, a second range and the second direction, and a third range in a third direction, where the first direction, the second direction, and the third direction are orthogonal. The first range, the second range, and the third range can be the same or different ranges.

Each connector receptacle 1102 can include tongue 1110 supporting a number of contacts 1120. Contacts 1120 can terminate in surface-mount contacting portions 1122 at a bottom side of connector receptacle structure 1100. Side ground contacts 1128 can flank tongue 1110 on each end. Housing 1140 of connector receptacle 1102 can support tongue 1110 and can include post 1142 extending from housing 1140 of connector receptacles 1102. Connector receptacles 1102 can each include a guide 1160 at a front around tongue 1110.

Frame 1170 can be shielded by shield 1150. Frame 1170 can include tab portion 1176 that can fit with notch 1154 in shield 1150. Frame 1170 can include posts 1172 and posts 1174. Frame 1170 can support alignment pin 1190. Shield 1150 can include tabs 1152 tabs where each tab 1152 can include opening 1153 that can act as a solder anchor to enhance a mechanical strength of a connection to a board (not shown.)

During assembly, posts 1172 can be inserted in corresponding openings in the board. Similarly, posts 1142 can be inserted into corresponding openings in the board. Post 1142 can help to align connector receptacles 1102 in a front to back direction. Tabs 1152 of shield 1150 can be inserted into openings or holes in the board. During reflow, a force can be applied to a top of each connector receptacle 1102 in a direction towards a board, thereby engaging surface-mount contacting portions 1122 of contacts 1120 with corresponding pads (not shown) on the board. After reflow, alignment pin 1190 can be used to align connector receptacle structure 1100 to an enclosure or portion of an enclosure of an electronic device (not shown.) Alignment pin 1190 can be formed of metal to provide additional strength to connector receptacle structure 1100. Additional posts 1174 can be used to align connector receptacle structure 1100 to an enclosure or other portions of the electronic device.

During reflow, it can be desirable to hold connector receptacles 1102 in place in frame 1170 of connector receptacle structure 1100. Also during reflow, it can be desirable to apply a force to each connector receptacle 1102 such that surface-mount contacting portions 1122 can be soldered to pads on the board. Accordingly, a reflow cap that can secure tongues 1110 of connector receptacles 1102 in a lateral direction can be used in conjunction with posts 1142 that can secure connector receptacles 1102 in a front and back direction. In this way, connector receptacles 1102 can be held in place while a force is applied to each connector receptacle 1102. An example is shown in the following figure.

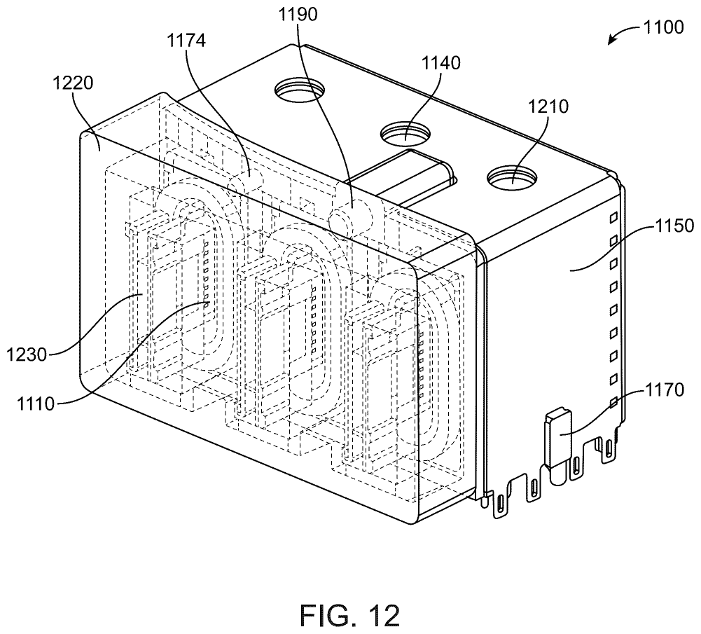

FIG. 12 illustrates a reflow cap and a connector receptacle structure according to an embodiment of the present invention. Connector receptacle structure 1100 can include frame 1170 supporting a number of connector receptacles 1102. Reflow cap 1220 can have features to align to post 1174 and alignment pin 1190 of connector receptacle structure 1100. Reflow cap 1220 can be attached to a front of connector receptacle structure 1100 during assembly. Following reflow, reflow cap 1220 can be removed.

Reflow cap 1220 can include a number of holders 1230, each for holding a tongue 1110 of a connector receptacle 1102. In this way, reflow cap 1220 can hold connector receptacles 1102 in place in a lateral direction across the faces of connector receptacles 1102. Posts 1142 (shown in FIG. 11) can fix connector receptacles 1102 in place in a front to back direction.

During reflow, a force can be applied through opening 1210 in shield 1150 and frame 1170 to a top of housing 1140 of each connector receptacle 1102. This force can act in a downward direction such that surface-mount contacting portions 1122 (shown in FIG. 11) can engage in be soldered to pads on a board (not shown.)

This force can be applied in various ways in various embodiments of the present invention. For example, force can be applied at each opening 1210 in a one-at-a-time or sequential manner. Alternatively, a tool can be placed over connector receptacle structure 1100 having projections corresponding to openings 1210. These projections can be fixed, they can be spring biased, or they can be other types of projections. These projections can apply force to some or all of housings 1140 of connector receptacles 1102 simultaneously. The force applied can help to compensate for warping and other non-planetary features of the board, as well as a lack of planarity of surface-mount contacting portions 1122.

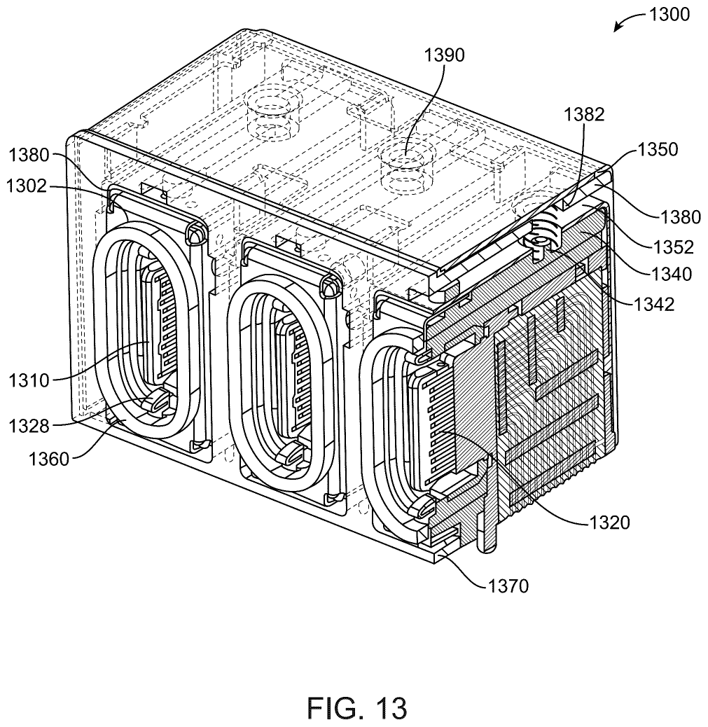

FIG. 13 illustrates another connector receptacle structure according to an embodiment of the present invention. Connector receptacle structure 1300 can be housed in an electronic device, such as computing device 110, monitor 120 (both shown in FIG. 1), or other electronic device. Connector receptacle structure 1300 can include a number of connector receptacles 1302, each housed in a corresponding slot 1380 in frame 1370. Connector receptacles 1302 can each move through a range of distances within slots 1380. Specifically, connector receptacles 1302 can each move through a first range in a first direction, a second range and the second direction, and a third range in a third direction, where the first direction, the second direction, and the third direction are orthogonal. The first range, the second range, and the third range can be the same or different ranges.

Connector receptacles can each include guide 1360, tongue 1310, and contacts 1320 supported by housing 1340. Side ground contacts 1328 can be positioned at each end of tongue 1310.

Individual forces can be applied to each connector receptacle 1302 at a top of housing 1340. These individual forces can be provided by springs 1390 that can be positioned between top shield 1350 and housing 1340. Springs 1390 can pass through openings in top housing 1382 and inner shield 1352. Tabs 1342 can extend from each housing 1340 and be positioned in the center of each spring 1390. Spring 1390 can be under compression and can push housings 1340 of connector receptacles 1102 towards a board (not shown.) This can help to engage surface mount contacting portions (not shown) of contacts 1120 with pads (not shown) on the board during reflow, as well as at other times. An additional force can be applied to the entire connector receptacle structure 1100 during reflow as well.

In various embodiments of the present invention, contacts, shields, and other conductive portions of a connector receptacle or connector receptacle structure can be formed by stamping, metal-injection molding, machining, micro-machining, 3-D printing, or other manufacturing process. The conductive portions can be formed of stainless steel, steel, copper, copper titanium, phosphor bronze, or other material or combination of materials. They can be plated or coated with nickel, gold, or other material. The nonconductive portions, such as the reflow caps, housings, frames, and other structures can be formed using injection or other molding, 3-D printing, machining, or other manufacturing process. The nonconductive portions can be formed of silicon or silicone, rubber, hard rubber, plastic, nylon, liquid-crystal polymers (LCPs), ceramics, or other nonconductive material or combination of materials. The printed circuit boards used can be formed of FR-4 or other material.

Embodiments of the present invention can provide connector receptacles that can be located in, and can connect to, various types of devices, such as portable computing devices, tablet computers, desktop computers, laptops, all-in-one computers, wearable computing devices, cell phones, smart phones, media phones, storage devices, portable media players, navigation systems, monitors, power supplies, video delivery systems, adapters, remote control devices, chargers, and other devices. These connector receptacles can provide interconnect pathways for signals that are compliant with various standards such as one of the Universal Serial Bus (USB) standards including USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. Other embodiments of the present invention can provide connector receptacles that can be used to provide a reduced set of functions for one or more of these standards. In various embodiments of the present invention, these interconnect paths provided by these connector receptacles can be used to convey power, ground, signals, test points, and other voltage, current, data, or other information.

Embodiments of the present invention can provide connector receptacles that can be located in various types of devices, such as tablet computers, laptop computers, desktop computers, all-in-one computers, cell phones, storage devices, wearable-computing devices, portable computing devices, portable media players, navigation systems, monitors, remotes, adapters, and other devices.

While embodiments of the present invention are well-suited to use in connector receptacles, these and other embodiments of the present invention can be utilized in connector inserts and other types of connectors as well. Also, while the connector receptacles shown herein are Universal Serial Bus Type-C connector receptacles, embodiments of the present invention can provide connector receptacles and connector receptacle structures compatible with other standards or specifications.

Reference numbers are used consistently throughout the figures and their descriptions. While features are shown on one side of a tongue in the above examples, the same or similar features can be repeated on an opposite side of the tongue.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A connector receptacle comprising:
a housing forming a passage;
a plurality of contacts supported by the housing, each of the plurality of contacts having a first region coated with a non-solderable coating; and
a plurality of solder tails, each solder tail having an end to be soldered to a board, each solder tail attached to a corresponding one of the plurality of contacts and having a second region coated with a non-solderable coating, wherein the second region is between the first region and the end of the solder tail, each solder tail having a solder region at least partially between the first region and the second region, the solder region to attach the solder tail to the corresponding one of the plurality of contacts.

2. The connector receptacle of claim 1 wherein for each contact, when a temperature of the solder in the solder region exceeds its melting temperature, the second region moves away from the first region.

3. The connector receptacle of claim 1 wherein for each contact, when a temperature of the solder in the solder region exceeds its melting temperature, the surface tension of the solder in the solder region moves the second region away from the first region.

4. The connector receptacle of claim 1 wherein for each contact, when a temperature of the solder in the solder region exceeds its melting temperature, the surface energy of the solder is increased, the surface area of the solder on the contact and corresponding solder tail increases, and the second region moves away from the first region.

5. The connector receptacle of claim 1 wherein the connector receptacle is one of a plurality of connector receptacles in a frame, wherein the frame is located in an electronic device.

6. The connector receptacle of claim 5 wherein each of the plurality of solder tails terminate in a surface-mount contacting portion.

7. The connector receptacle of claim 6 wherein the plurality of contacts are supported by a tongue, and the tongue is supported by the housing.

8. A connector receptacle comprising:
a housing forming a passage;
a plurality of contacts supported by the housing, each of the plurality of contacts having a first region coated with a non-solderable coating; and
a plurality of solder tips, each solder tip attached to a corresponding one of the plurality of contacts, each solder tip comprising a volume of solder, wherein the first region extends from at least a surface of the solder tip a distance away from the solder tip.

9. The connector receptacle of claim 8 wherein for each contact in the plurality of contacts, the first region extends from within the solder tip a distance away from the solder tip.

10. The connector receptacle of claim 8 wherein for each contact in the plurality of contacts, when a temperature of the solder in the solder tip exceeds its melting temperature, the solder of the solder tip moves away from the first region.

11. The connector receptacle of claim 8 wherein the connector receptacle is one of a plurality of connector receptacles in a frame, wherein the frame is located in an electronic device.

12. The connector receptacle of claim 11 wherein the plurality of contacts are supported by a tongue, and the tongue is supported by the housing.

13. The connector receptacle of claim 12 wherein the connector receptacle is a Universal Serial Bus Type-C connector receptacle.

14. A connector receptacle structure comprising:
a frame having a plurality of slots; and
a plurality of connector receptacles each located in a corresponding one of the plurality of slots, wherein each connector receptacle can move in its corresponding slot through a first range in a first direction, a second range in a second direction, and a third range in a third direction, wherein the first direction, the second direction, and the third direction are orthogonal.

15. The connector receptacle structure of claim 14 wherein each of the plurality of connector receptacles comprises:
a housing; and
a plurality of contacts supported by the housing,
wherein each of the plurality of contacts comprises a surface-mount contacting portion, wherein the first direction is the vertical direction and the surface-mount contacting portions are below the housing.

16. The connector receptacle structure of claim 15 wherein the frame comprises a plurality of openings in a top portion such that a top of each housing of each of the connector receptacles is accessible through a corresponding one of the plurality of openings in the top portion of the frame.

17. The connector receptacle structure of claim 16 wherein during assembly, a force can be applied to the top of each housing of each of the connector receptacles through a corresponding one of the plurality of openings in the top portion of the frame during a reflow step to provide a connection between each of the surface-mount contacting portions and a corresponding pad on a board.

18. The connector receptacle structure of claim 16 wherein for each of the plurality of connector receptacles, the plurality of contacts are supported by a tongue, and the tongue is supported by the housing.

19. The connector receptacle structure of claim 18 wherein each connector receptacle is a Universal Serial Bus Type-C connector receptacle.

20. The connector receptacle structure of claim 16 further comprising a shield over the top portion of the frame, and a plurality of springs, each spring in a corresponding one of the plurality of openings in the top portion of the frame and between the shield and a housing of a corresponding connector receptacle.
